(19) United States
(12) Patent Application Publication
(10) Pub. No.: US 2006/0212897 A1
(43) Pub. Date: Sep. 21, 2006

(54) System and method for utilizing the content of audio/video files to select advertising content for display

(75) Inventors: Ying Li, Bellevue, WA (US); Li Li, Issaquah, WA (US); Tarek Najm, Kirkland, WA (US); Hongbin Gao, Beijing (CN); Benyu Zhang, Beijing (CN); Xianfang Wang, Beijing (CN); Frank T.B. Seide, Hamburg (DE); Roger Peng Yu, Beijing (CN); Hua-Jun Zeng, Beijing (CN); Jian-Lai Zhou, Beijing (CN); Zheng Chen, Beijing (CN)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/084,616

(22) Filed: Mar. 18, 2005

(51) Int. Cl. H04N 7/10; H04N 7/025

(52) U.S. Cl. 725/32

(57) ABSTRACT

Systems and methods for analyzing the content of audio/video files using speech recognition and data mining technologies are provided. As it can generally be assumed that a user's interest is highly correlated with an audio/video clip or television program the user may be watching, methods and systems for utilizing the results of speech recognition and data mining technology implementation to retrieve relevant advertising content for display are also provided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### TECHNICAL FIELD

The present invention relates to computing environments. More particularly, embodiments of the present invention relate to systems and methods for analyzing the content of audio/video files (e.g., audio/video clips, television programs, or audio/video streams) using speech recognition and data mining technologies. Additionally, embodiments of the present invention relate to utilizing the results of speech recognition and data mining technology implementation to retrieve relevant advertising content for display.

### BACKGROUND OF THE INVENTION

In typical web-advertising business models, advertising revenue depends on two key factors: the ad-keyword market price and the click-through probability. The ad-keyword market price is determined through auctioning; a process wherein multiple advertisers are permitted to bid for association of their advertising content with a particular keyword, the bid price being correlated with the ad-keyword market price. The click-through probability is a statistical value which represents the likelihood that a user will “click” a displayed advertisement, thereby accessing additional information and/or completing a purchase. A click-through is generally necessary for an advertiser to profit from the display of its advertisement and is determined largely by the current interests of the users. For efficient advertising, a balance needs to be achieved between these two factors.

In conventional real-time television advertising, advertising content is pre-defined and only broadly if at all related to the content of the television program. This pre-defined method of advertising reduces the effectiveness of the advertisements being shown when it is not relevant to the users or the current topic of the television program.

Conventional processes for categorizing audio/video media files require a human user to listen to and/or view an audio/video file and then manually annotate the file with a summary of its content. Such processes are laborious and time-consuming, not to mention extremely inefficient.

Accordingly, a method for categorizing the content of audio/video files which is less laborious than conventional processes would be desirable. Additionally, a method for utilizing information about the categorization of an audio/video file to select advertising content that is relevant to the user would be advantageous. Further, a method for increasing the relevance of the advertising content displayed in association with an audio/video file (e.g., an audio/video clip or a real-time television program) would be advantageous.

### BRIEF SUMMARY OF THE INVENTION

Embodiments of the present invention provide a method for utilizing the content of audio/video files to select advertising content for display. In one aspect, the method may include receiving an audio/video file, analyzing the audio/video file using speech recognition technology, extracting one or more keywords from the audio/video file, and retrieving at least one advertisement for display based upon the one or more extracted keywords. The method may further include displaying the at least one advertisement in association with the audio/video file.

Embodiments of the present invention further provide computer systems for utilizing the content of audio/video files to select advertising content for display. The computer system may include a receiving component for receiving an audio/video file, an analyzing component for analyzing the audio/video file using speech recognition technology, an extracting component for extracting one or more keywords from the audio/video file, and a retrieving component for retrieving at least one advertisement for display based upon the one or more extracted keywords. The computer system may further include a displaying component for displaying the at least one advertisement in association with the audio/video file.

Computer-readable media having computer-executable instructions for performing the methods disclosed herein are also provided.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a schematic diagram of an exemplary system architecture in accordance with an embodiment of the present invention;

FIGS. 3A and 3B are a flow diagram illustrating a method for analyzing the content of audio/video files (e.g., audio/video clips, television programs, or audio/video streams) using speech recognition and data mining technologies and utilizing the results of such analysis to retrieve relevant advertising content for display, in accordance with an embodiment of the present invention;

FIG. 4 is a schematic diagram of the infrastructure of a real-time contextual advertising system in accordance with an embodiment of the present invention; and

FIG. 5 is a schematic diagram illustrating the flow of data for a real-time television contextual advertising system in accordance with an embodiment of the present invention.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems and methods for analyzing the content of audio/video files using speech recognition and data mining technologies. As it can generally be assumed that a user's interest is highly correlated with an audio/video clip, television program, or audio/video stream (e.g., a live broadcast or web stream) the user may be watching, embodiments of the present invention further provide methods and systems for utilizing the results of speech recognition and data mining technology implementation to retrieve relevant advertising content for display.

Thus, embodiments of the present invention provide systems and methods for selecting relevant advertising content for display in association with an audio/video clip, television program, or audio/video stream the user may be watching based upon automatic analysis of the content of the audio/video clip, television program, or audio/video stream and the content of an advertisement, which content may be described by keywords or ad-words. The systems and methods described herein are fully automated and facilitate selection of contextual advertising content in response to specific topics that are relevant to the content that the user is watching. Audio/video clips, television programs, and/or audio/video streams are processed by speech recognition and phonetic search technologies and keywords are extracted therefrom using data mining technologies. The extracted keywords represent topics that are an approximation of the user's interests. Subsequently, utilizing the extracted keywords, relevant advertisements are retrieved for the current user and displayed. If desired, advertising content retrieval may also take into account other factors such as click-through probabilities and monetization values for the keywords.

Utilizing the systems and methods described herein, the need for a human editor to choose advertising content or determine descriptive keywords is alleviated. Further, the asynchronous nature and auction-based business models of the web environment are leveraged in that changing ad-keyword market values are dynamically taken into account. Still further, if available, user-profile information may be utilized, further tuning advertising towards a user's interests.

Having briefly described an overview of the present invention, an exemplary operating environment for the present invention is described below.

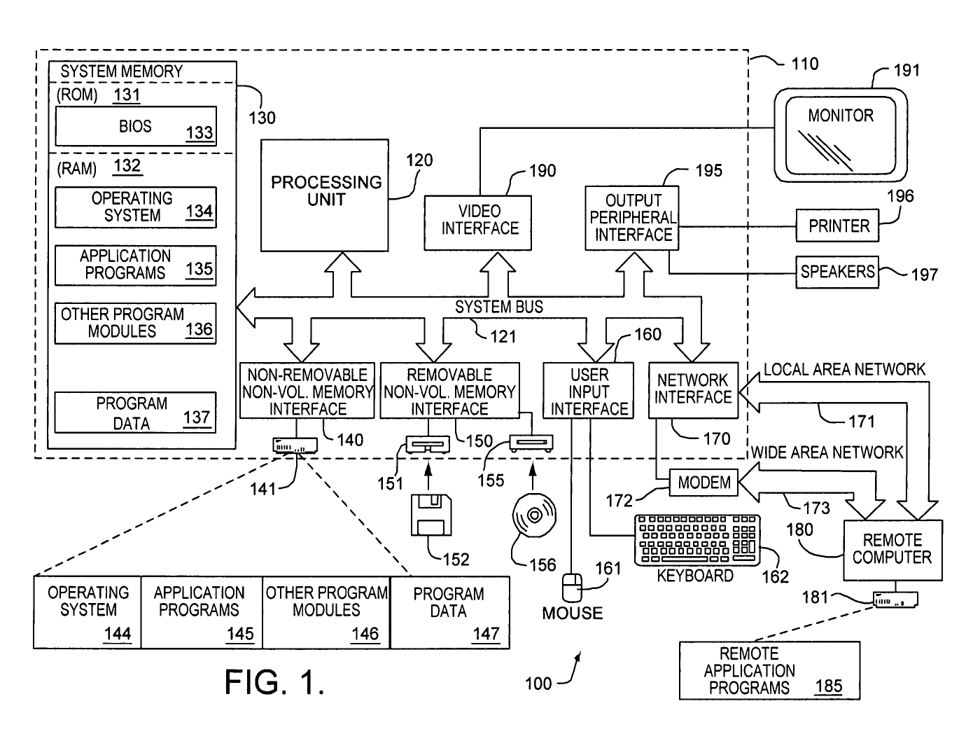

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

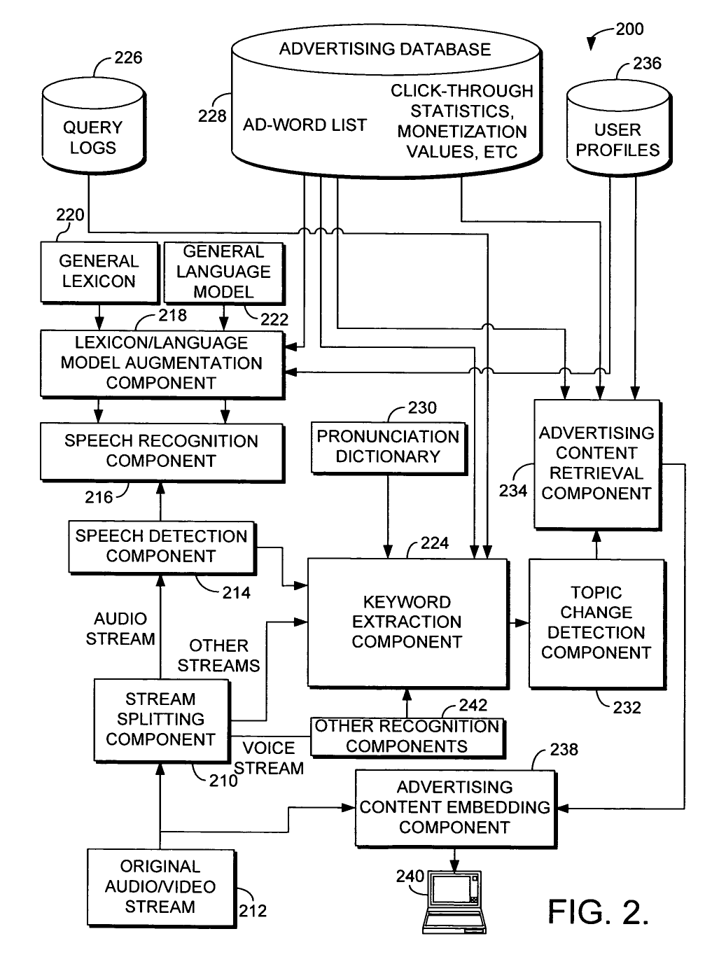

As previously mentioned, embodiments of the present invention relate to systems and methods for analyzing the content of audio/video files (e.g., audio/video clips, television programs, or audio/video streams) using speech recognition and data mining technologies and utilizing the results of such analysis to retrieve relevant advertising content for display. Turning to FIG. 2, a block diagram is illustrated which shows an overall system architecture for audio/video content analysis and advertising content retrieval in accordance with an embodiment of the present invention, the overall system architecture being designated generally as reference numeral 200.

The system 200 includes a stream splitting component 210 for splitting an original audio/video stream 212 into one or more of an audio stream, a video stream, a caption stream (i.e., containing close-captions), and other metadata streams, depending upon what is available in the original audio/video stream 212 received. The system 200 further includes a speech detection component 214 for receiving audio output from the stream splitting component 210 and detecting, in the output, speech and non-speech. Additionally included is a speech recognition component 216 for receiving output from the speech detection component 214 and outputting a symbolic representation of the content thereof, as more fully described below. The speech recognition component 216 also receives input from a lexicon/language model augmentation component 218 which augments general lexicons 220 and language models 222, also more fully described below.

The system 200 further includes a keyword extraction component 224 for extracting keywords from the original audio/video file and comparing the extracted keywords to a list of ad-words to determine matches. The keyword extraction component 224 receives input from query logs 226, that is, logs of various users' queries to a search engine, an advertising database 228 wherein an ad-word list for comparison to the extracted keywords may be stored, a pronunciation dictionary 230, as well as the output from the speech recognition component 216 and the close caption, metadata, and video streams from the stream splitting component 210.

Still further, the system 200 includes an a topic change detection component 232 for re-weighting the extracted keywords in an attempt to detect changes in topic. The purpose of the topic change detection component 232 is to accommodate for the fact that the original audio/video stream may contain multiple topics. The system 200 additionally contains an advertising content retrieval component 234 for retrieving advertising content (i.e., one or more advertisements) that is associated with the ad-words having the closest match (or matches) to the extracted keywords. The advertising content retrieval component receives input from the advertising database 228 (in the form of an ad-word list and/or click-through statistics, monetization values and the like), as well as user profiles and/or behaviors 236, if available, and the output from the topic change detection component 232.

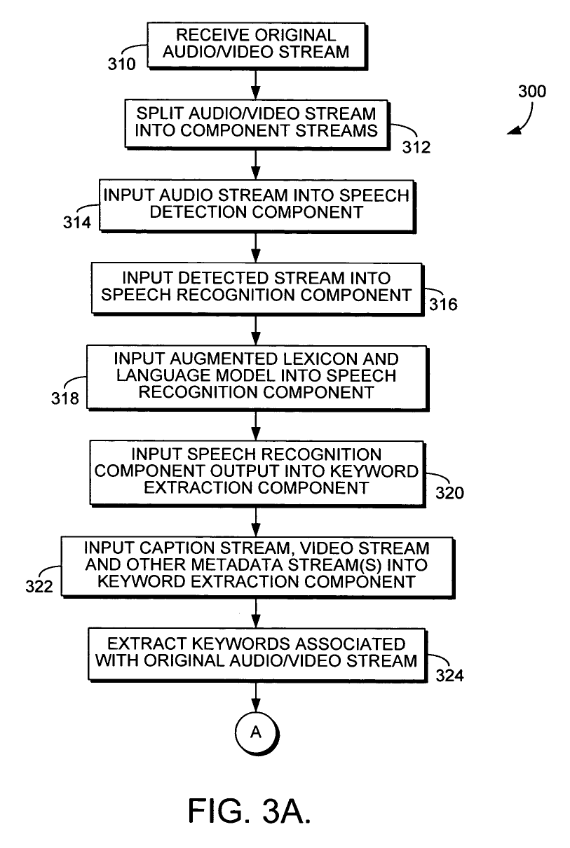

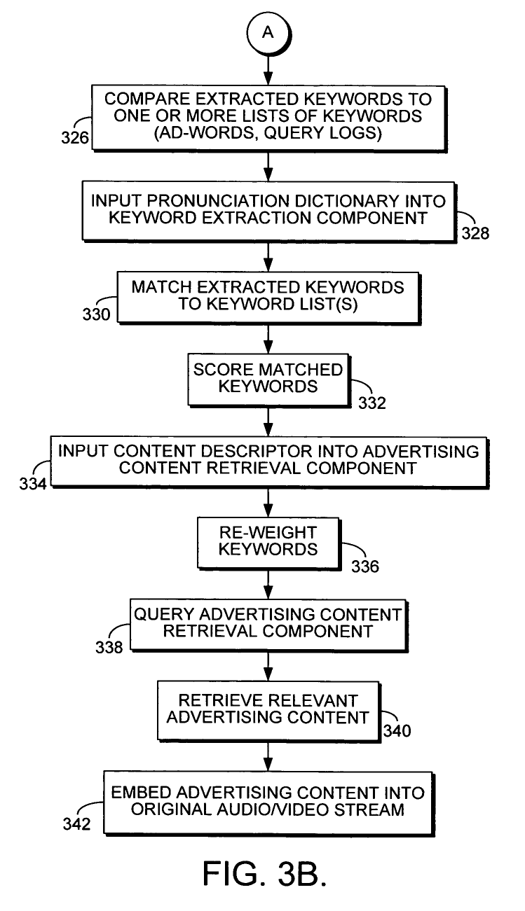

The system 200 additionally includes an advertising content embedding component 238 which embeds the advertising content retrieved from the advertising content retrieval component 234 into the original audio/video stream and displays them on an appropriate viewing device 240, e.g., a popular player or specialized renderer, or a television or projection screen. The functions performed by each of these system components are more fully described below with regard to the method illustrated in FIG. 3.

Advertising content for display on an appropriate viewing device is selected, in accordance with embodiments of the present invention, such that revenue to the advertising content provider (i.e., the advertiser) is maximized. This is a non-trivial problem. On one hand, it is desirable to choose advertising content that the user is most interested in to increase the chance that she/he will click on the content and thereby accesses further information and/or complete a purchase. On the other hand, the advertising content providing the highest monetization value based on ad-words is desired. These two goals oftentimes conflict and achieving a balance between them provides for the most efficient advertising possible to occur. A third factor is that speech recognition technology is not perfect and mistakes will inevitably be made. Thus, recognized words that are more likely correct should have a higher influence on the selection of the advertising content, since misrecognitions lead to advertisements that are uninteresting to the user.

The following probabilistic formula integrates and naturally balances these influence factors to yield maximal revenue in the statistical average and, thus, provides for the most efficient advertising possible. The goal is to choose the advertising content that maximizes the monetization value in the statistical sense (expected value). At certain time intervals (e.g., every fifteen seconds), one or a list of advertisements will be selected according to a probabilistic model that is designed to maximize the average (expected) monetization value. Mathematically, this can be represented by the following objective function:

$$( \hat{A} , \hat{W} ) = {arg }_{( A , W )} max \{ {E}_{C} ( {M}^{C} ( A , W ) \vert V , U ) \}$$

wherein A represents an advertisement, W represents an ad-word, V represents the video, U represents the user, C represents whether the user clicks through on the displayed advertisement or not, and Mc represents the monetization value for the pair (A,W) if the advertisement is clicked-through (C=TRUE, click-through) or not (C=FALSE, impression).

This objective function can be expanded into the following:
E_{C}(M^{C}(A,W)|V,U)=E_{C,I,R}_{_{V}}_{,R}_{_{U}}_{,T}(M^{C}(A,W)|V,U)=Σ_{Cε{T,F},Iε{T,F},R}_{_{V}}_{ε{T,F},R}_{_{U}}_{ε{T,F},T}M^{C}(A,W)·P(C,I,R_{V},R_{U},T|A,W,V,U)

wherein I represents whether the user is interested in the content of the advertisement or not, R_{V} represents whether the ad-word is relevant to the original audio/video stream, R_{U} represents whether the user has a historical interest in the ad-word, and T represents the text or speech recognition hypothesis.

The joint probability distribution shown above can be expanded into the following:
P(C,I,R_{V},R_{U},T|A,W,V,U)=P(C|I,A,U)·P(I|R_{V},R_{U})·P(R_{U}|W,U)·P(R_{V}|W,T)·P(T|V,U)

wherein each item represents information from different source. P (T|V,U) represents the probability that text T is correct given the original audio/video stream. This is provided by the speech recognition component 216 of FIG. 2. It is a probability that reflects the uncertainty about the correctness of the speech-recognition output. This probability can also represent closed-caption text, if available (it will then be either 1 or 0). Moreover, the formalism also allows this to be extended to other types of recognition components, for example Oprical Character Recognition (OCR) operating on the video stream. Other recognition components are indicated as reference numeral 242 in FIG. 2.

P(R_{V}|W,T) represents the probability that the ad-word W is relevant to text T, and is provided by the keyword extraction component 224 of FIG. 2. Instead of a strict probability, common probabilistic relevance measures such as TF.IDF may be incorporated. (As will be understood by those of ordinary skill in the art, TF.IDF is the standard technique used in text information retrieval for ranking documents by relevance to a query.)

P(R_{U}|W,U) represents the probability that the user has a general interest in the keyword (independent of the current interest). This information is available from the user profile and/or behaviors 236 (FIG. 2), if available. It will be understood and appreciated by those of ordinary skill in the art that if no user profile and/or behavior information is available, this component may be removed from the joint probability distribution. All such variations are contemplated to be within the scope hereof.

P(I|R_{V}, R_{U}) represents the probability that the user is interested in the content of the advertisement(s). The purpose of this is to integrate the user's historical interest (R_{V}) and the user's momentary interest (represented by the audio/video stream being watched, R_{V}).

P(C|I,A,U) represents the probability that the user will click on an advertisement, taking into account whether she/he is/is not interested in the content of the advertisement. This information is available from the advertisements' click-through statistics (stored in the advertising database 228 of FIG. 2) and the user profile and/or behaviors 236 (FIG. 2). This reflects that even a user not interested in the content of an advertisement may click it (e.g., depending on how attractive an advertisement is designed), and that a user, despite being interested, may not necessarily click on the advertisement.

Turning now to FIGS. 3A and 3B, a method for analyzing the content of audio/video files (e.g., audio/video clips, television programs, or audio/video streams) using speech recognition and data mining technologies and utilizing the results of such analysis to retrieve relevant advertising content for display in accordance with an embodiment of the present invention is illustrated and designated generally as reference numeral 300. Initially, as indicated at block 310, an original audio/video stream is received and input into the system. The audio/video stream is subsequently split into one or more component streams, as indicated at block 312. The component stream may include an audio stream, a video stream, a caption stream (i.e., containing close-captions), and other metadata streams, depending upon what is available in the original audio/video stream received.

Subsequently, the audio stream is input into the speech detection component (214 of FIG. 2) to detect speech and non-speech in the audio stream, as indicated at block 314. The output of the speech detection component (214 of FIG. 2) is subsequently processed by the speech recognition component (216 of FIG. 2). This is indicated at block 316.

The purpose of speech recognition is to provide a symbolic representation of the audio stream of the original audio/video stream, and associated with it, the probability distribution information P(T|V,U). This information may be delivered in several forms. First, the information may be delivered either in the form of a text transcript or a lattice. While a text transcript encodes only a single recognition hypothesis (the one that scores highest), lattices facilitate implementing the full criterion to have access to all plausible alternates that are considered by the speech recognition component (216 of FIG. 2). Lattices are a compact representation to encode a large amount of recognition alternates in a graph structure.

Secondly, the information may be delivered either as words or as a phonetic representation. Conventional large-vocabulary speech recognition components generally have a fixed vocabulary. Only words in this vocabulary are capable of being recognized. An alternative to such fixed-vocabulary speech recognition components are phonetic recognition components. Such components generate a phonetic representation, against which keywords are matched by their pronunciation. Hybrid word/phonetic-based recognition components are also possible and are contemplated to be within the scope of the present invention.

Additionally, the information may be delivered as score and time information. To implement the full score, as more fully described below, recognition scores (which give information on how accurate a match is) may be included in the output. Time information is useful to handle multiple-word keyphrases.

Speech recognition may be enhanced by augmenting the lexicon by the keyword list using the lexicon/language model augmentation component (218 of FIG. 2) and inputting the augmented information into the speech recognition component (216 of FIG. 2). This is indicated at block 318. This enables the speech recognition component (216 of FIG. 2) to deal with keywords that are not originally in the generic speech-recognition lexicon (220 of FIG. 2). Without this, keywords that are not in the vocabulary cannot be recognized. An alternative is to use a phonetic match, as hereinabove described.

Speech recognition may also be enhanced by augmenting a general language model (LM) (222 of FIG. 2) using the lexicon/language model augmentation component (218 of FIG. 2) with knowledge about the language context in which the added keywords occur. This provides better accuracy for those keywords. One possibility to achieve this is to mine a network, e.g., the web, for additional LM training material.

Additionally, speech recognition may be enhanced by using the user's profile (236 of FIG. 2), if available, to update the language model to better match the type of content that the user is commonly watching. This may be accomplished by inputting the user's profile, if available, into the lexicon/language model augmentation component 218, as shown in FIG. 2.

With reference back to FIG. 3, the symbolic output of the speech recognition component (216 of FIG. 2) is subsequently input into the keyword extraction component (224 of FIG. 2), as indicated at block 320. Additionally input into the keyword extraction component (224 of FIG. 2) are the caption stream, video stream, and/or metadata stream of the original audio/video stream (212 of FIG. 2). This is indicated at block 322.

Once all input has been received, keywords associated with the original audio/video stream are extracted from the output of the speech recognition component (216 of FIG. 2), as indicated at block 324. The extracted keywords are subsequently compared to one or more lists of keywords provided by the system, as indicated at block 326. The list(s) of keywords may be based on an ad-word dictionary stored in an advertising database (228 of FIG. 2) and/or on query logs, that is, on logs of various users' queries to a search engine. Additionally, a pronunciation dictionary may be input into the keyword extraction component (224 of FIG. 2), as indicated at reference numeral 328.

The keyword extraction component not only extracts keywords from the various media streams that make up the original audio/video stream (212 of FIG. 2) and compares the extracted keywords to the keyword lists and pronunciation dictionary, it also matches advertising keywords to the keywords associated with the original audio/video stream. This is indicated at block 330. Keyword matching can be done by spelling or by pronunciation (phonetic matching). The keywords are subsequently given a score based upon a combination of relevance and confidence scores, as indicated at block 332.

This keyword extraction component (224 of FIG. 2) provides P(R_{V}|W,T). By combining P(T|V,U) (from the speech recognition component (216 of FIG. 2)) and P(R_{V}|W,T), P(R_{V}|W,U,V) may be obtained as the following probability distribution:
P(R_{V}|W,V,U)=Σ_{T}P(R_{V}|W,T)·P(T|V,U)

This probability distribution is what “describes” the content and may be referred to as the “content descriptor.” Referring back to FIG. 3, as indicated at block 334, this “content descriptor” is input into the advertising content retrieval component (234 of FIG. 2). Again, different representations are possible and are more fully described below with respect to the advertising content retrieval component interface.

The keyword extraction component is based on techniques for word-based and phonetic audio search, as more fully described in Seide, et al., Vocabulary-Independent Search in Spontaneous Speech; In Proc., ICASSP 2004, Montreal; and Yu et al., A Hybrid Word/Phoneme-Based Approach for Improved Vocabulary-Independent Search in Spontaneous Speech, In Proc., ICSLP 2004, Jeju, each of which is hereby incorporated by reference as if set forth in its entirety herein.

Subsequently, the keywords are re-weighted in an attempt to detect changes in topic, as indicated at block 336. This is to accommodate for the fact that the original audio/video stream may contain multiple topics.

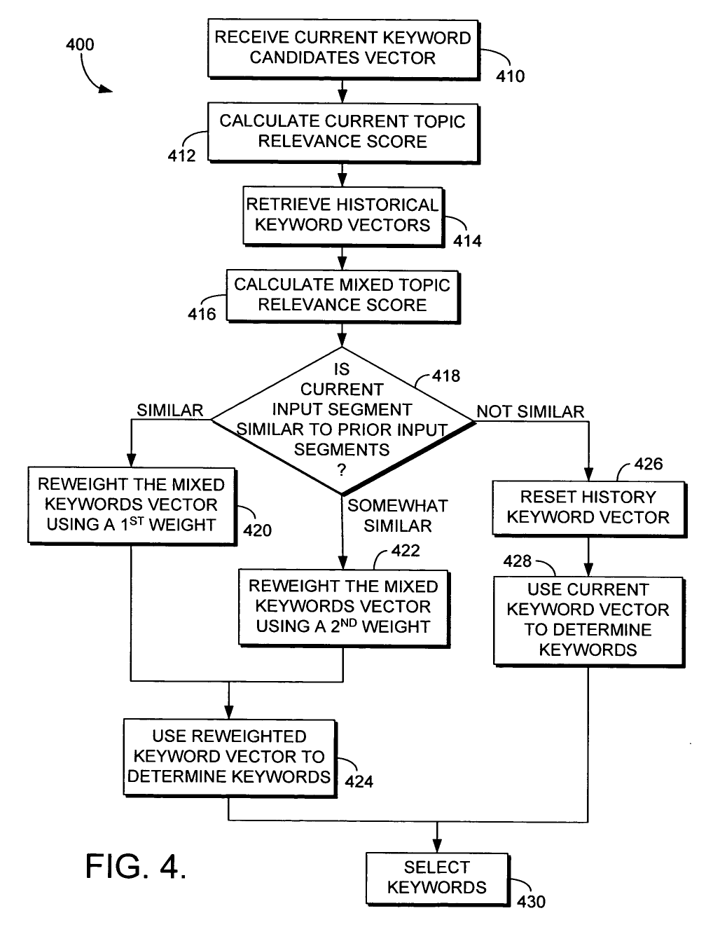

To maintain continued relevance of the advertisements being displayed, contextual advertisements are updated at a regular rate. Thus, the keyword extraction component preferably extracts keywords periodically, e.g., every fifteen seconds, rather than waiting until the end of a topic. Thus, compared to conventional keyword-extraction methods, the methods of the present invention utilize a “history feature” wherein keywords extracted from the previous input segments are utilized to aid extraction of the current input segment. Topic change detection and keyword re-weighting are more fully described below with reference to FIG. 4.

Turning to FIG. 4, a method for topic change detection and keyword re-weighting is illustrated and designated generally as reference numeral 400. Initially, as indicated at block 410, the current keyword candidates vector is received and a current topic relevance score is calculated, as indicated at block 412. To accomplish this, historical information is utilized to detect topic changes. Keyword vectors are generated and stored for several prior input segments, e.g., the prior four input segments, in an audio/video stream. Subsequently, these historical keyword vectors are retrieved, as indicated at block 414, and added to the current keyword candidates vector. Subsequently, a mixed topic relevance score between the current input segment and the earlier input segments may be calculated, as indicated at block 416.

Subsequently, it is determined if the current input segment is similar to the prior input segments. This is indicated at block 418. If the mixed topic relevance score between the current input segment and the prior input segments is larger than a first threshold a₁, e.g., 0.0004, the current input segment may be regarded as similar to the earlier input. In this scenario, the history keyword vectors are aged with the current keyword candidate vector using a first weight w₁, such as 0.9. This is indicated at block 420. The mixed, re-weighted keyword vectors are subsequently used for keyword selection and advertisement retrieval, as indicated at block 424 and as more fully described below.

If the mixed topic relevance score between the current input segment and the prior input segments is less than the first threshold a₁, but larger than a second threshold a₂ (a₁<a₂), e.g., 0.0001, the current input segment may be regarded as somewhat similar to the earlier input segment. In this scenario, the history keyword vectors are aged with the current keyword candidate vector using a second weight w₂ (w₂<w₁), e.g., 0.5. This is indicated at block 422. The mixed keyword vectors are subsequently used for keyword selection and advertisement retrieval, as indicated at block 424 and as more fully described below.

If the mixed topic relevant score is less than the second threshold a₂, the current input segment is regarded as not similar to the earlier input segment, and the history keyword vector may be reset, as indicated at block 426. In this scenario, the current keyword vector subsequently may be used for keyword selection and advertisement retrieval, as indicated at block 428 and as more fully described below.

Subsequently, based upon the current or re-weighted keyword vectors, whichever is appropriate, keywords may be selected for utilization in advertisement retrieval, as more fully described below. This is indicated at block 430.

With reference back to FIG. 3, the re-weighted or current keyword vectors, whichever is appropriate, are subsequently used to generate a “modified content descriptor” which may be used as the query of the advertising content retrieval component (234 of FIG. 2). This is indicated at block 338. In one embodiment, the advertising content retrieval component (234 of FIG. 2) includes sub-components to evaluate P(R_{U}|W,U), P(I|R_{V},R_{U}) and P(C|I,A,U). In a currently preferred embodiment, all information is integrated together to get the optimum decision according to the criteria described hereinabove.

It may be desirable to simplify the form of the modified content descriptor, e.g., to enable reuse of existing advertising content retrieval components designed for paid-search (with the input being queries input by search-engine users), or to better integrate with ranking functions of existing components. Three forms of modified content descriptors that differ in their level of detail and simplification are discussed below.

First, a modified content descriptor may include multiple scored keywords. With this representation, the optimization criteria discussed hereinabove may be fully implemented. However, conventional advertising content retrieval components need to be (re-)designed to not only accept multiple keyword hypotheses but also incorporate the probabilities correctly into their existing ranking formulas. In this representation, a set of ad-words W_{BEST} and a score P(R_{V}|W,U,V) for each W in the set is available. The optimal advertisement is described by the following formula. It is the same as previous equations, but rewritten with the quantity T (text transcript) absorbed into P(R_{V}|W,U,V).

$$\begin{matrix}( \hat{A} , \hat{W} ) = {arg max }_{( A , W ) \text{:} W ∈ BEST} \{ {E}_{C} ( {M}^{C} ( A , W ) \vert V , U ) \} \\ = {arg max}_{( A , W ) \text{:} W ∈ WBEST} \{ {\sum }_{C , I , {R}_{V} , {R}_{U}} \begin{matrix}{M}^{C} ( A , W ) \cdot \\ P ( C , I , {R}_{V} , {R}_{U} \vert A , W , V , U )\end{matrix} \} \\ = {arg max}_{( A , W ) \text{:} W ∈ WBEST} \\ \{ {\sum }_{C , I , {R}_{V} , {R}_{U}} \begin{matrix}{M}^{C} ( A , W ) \cdot \\ P ( C , I , V , U )\end{matrix} = \begin{matrix}\begin{matrix}P ( I \vert {R}_{V} , {R}_{U} ) \cdot \\ P ( {R}_{V} \vert W , U , V ) \cdot \end{matrix} \\ P ( {R}_{U} \vert W , U )\end{matrix} \}\end{matrix}$$

Secondly, a modified content descriptor may include multiple keywords without scores. In this slightly simplified form, a hard decision is made in the keyword extraction and topic change detection stages about which ad-words are relevant to the audio/video stream by choosing the top-ranking ones according to P(R_{V}|W,U,V) and then quantizing P(R_{V}|W,U,V) to 1.0. The detailed interplay with the probability terms processed inside the advertising content retrieval component is disregarded, thus leading to less optimal monetization value than when multiple keywords are provided with scores.

In a third approach, a modified content descriptor may include only the best keyword. In this further simplified form, only one keyword is provided. This form is generally compatible with conventional advertising content retrieval components designed for paid-search applications, but this way will not lead to optimal average monetization value.

Each of the above-described modified content descriptors, or any combination thereof, may be utilized for the methods described herein and all such variations are contemplated to be within the scope of the present invention.

With continued reference to FIG. 3, relevant advertising content is subsequently selected and retrieved based upon the modified content descriptors, as indicated at block 340. Subsequently, as indicated at block 342, the retrieved advertising content is embedded into the original audio/video stream and displayed in association with the audio/video stream.

Advertising content may be embedded in one of two different ways. First, the entire advertisement may be embedded into the audio/video stream. A simple form of embedding advertisements is to display the entire advertisement as captions in the audio/video stream. Video captions are widely supported by many conventional media players. A more elaborate form of embedding is possible with modern object-based media-encoding formats such as MPEG-4. The video program designer can embed designated areas in the video as place-holders, such as a rectangular banner area at the top of the background, which would then be sub-planted by the actual advertising. Each of these alternatives, or any combination thereof, is contemplated to be within the scope of the present invention.

As an alternative to embedding the entire advertisement in the audio/video stream, the stream may simply be augmented with references (links) to the advertisement. In this mode, it is the responsibility of the user to actually download the advertisement. The link can be dynamic (referring to the final advertisement) or static (encoding the query to the advertising content retrieval component instead). In the latter mode, to access the advertisement, the user actively communicates with the advertising content retrieval component to retrieve the advertisement. This allows for pre-processing and storing the video augmented with static advertisement information, as well as bandwidth savings by multi-cast distribution.

When the original audio/video stream is a real-time television program, the entire text of the advertisement will generally be embedded into the program.

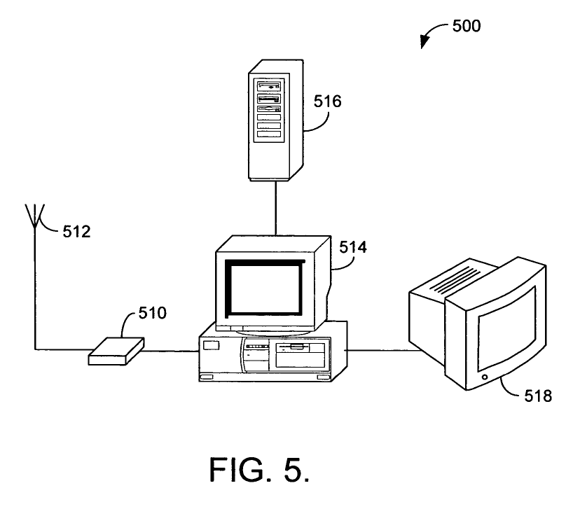

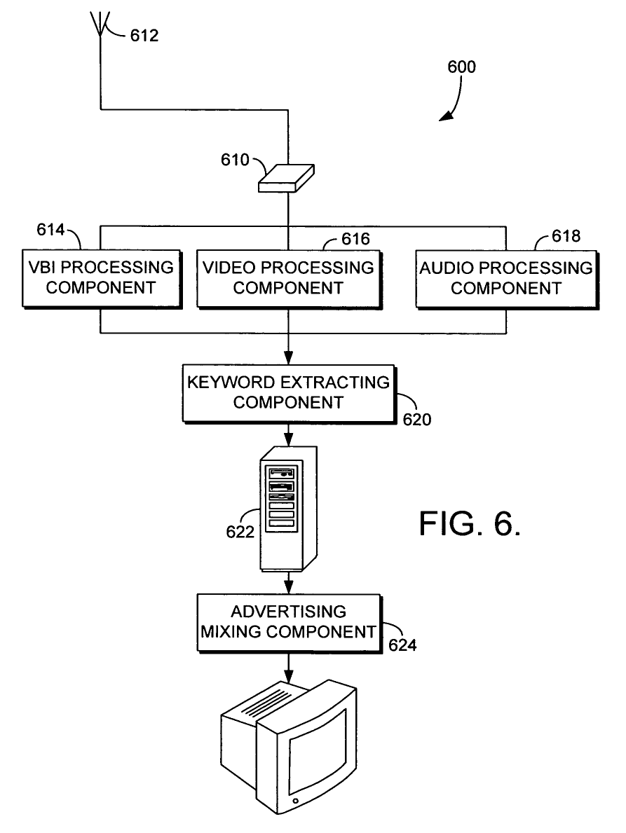

Turning to FIG. 5, an exemplary infrastructure for a real-time television contextual advertising system is illustrated and designated generally as reference numeral 500. In the contextual advertising system for real-time television programming, a television card 510 receives a television signal from a cable or antenna 512. A computing device 514 subsequently decodes the television signal into audio, video, and VBI information (that is, text information that is transmitted digitally during the vertical blanking interval). Then, the audio, video and VBI information may be used to extract content descriptors (keywords or ad-words) relevant to the television program being viewed in accordance with the methods hereinabove described. This can be done live on the user side or pre-computed on the server. Subsequently, the content descriptors may be input into an advertising server 516 to retrieve relevant advertising for the current user. The relevant advertising content is subsequently displayed on a viewing device 518, e.g., a television.

With reference to FIG. 6, the data flow of a real-time contextual advertising system in accordance with an embodiment of the present invention is illustrated and designated generally as reference numeral 600. Initially, a television card 610 receives a television signal from a cable or antenna 612. The signals of some television channels carry VBI information, for example, Closed Caption (CC), Words Standard Teletext (WST) and eXtended Data Service (XDS). The VBI information is relevant to the current television program and may be extracted into the text transcript format by a decoder that is integral with the television card 610. Thus, the VBI information, video information and audio information may be decoded and processed by a VBI processing component 614, a video processing component 616 and an audio processing component 618, respectively. Subsequently, this processed information may be used by a keyword extraction component 620 to extract keywords relevant to the current television program utilizing the methods hereinabove described. It will be understood and appreciated by those of ordinary skill in the art that the use of VBI information is optional for the keyword extraction component.

Subsequently, the keywords retrieved by the keyword extraction component are input into an advertising server 622 as a query. The advertising server 622 subsequently inputs the advertising content that is relevant to the query to an advertising mixing component 624. If desired, the user's profile may also be input into the advertising server to retrieve advertising content that may be even more relevant to the user. Subsequently, the advertising mixing component 624 mixes the advertising content with the original video stream and the advertising content is displayed to the user in association with the television program, e.g., at the bottom of the television viewing screen 626.

As can be understood, the present invention provides a system for using speech recognition to create text files from audio/video content. This invention uses speech recognition technology to automatically generate text for video and audio media files, and then uses data mining technology to extract and summarize the content of the audio and video media files based on the text generated by speech recognition technology. This invention permits the retrieval and display of relevant advertising content according to the context of multimedia files in real-time or offline. That is, the invention matches the context of audio/video media files to the context of advertisements. The context of the audio/video files is generated by text mining technology and/or speech recognition technology. The context of advertisements is generated either the same way or through keywords/context provided by the advertiser. It can be applied to live television programs, audio/video on demand services, web streaming, and other multimedia environments.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A method for utilizing an audio/video file to select at least one advertisement for display, the method comprising:
receiving the audio/video file;
analyzing the audio/video file using speech recognition technology;
extracting one or more keywords from the audio/video file; and
retrieving at least one advertisement for display based upon the one or more extracted keywords.

2. The method of claim 1, further comprising displaying the at least one advertisement in association with the audio/video file.

3. The method of claim 2, wherein displaying the at least one advertisement in association with the audio/video file comprises embedding the at least one advertisement in the audio/video file.

4. The method of claim 2, wherein displaying the at least one advertisement in association with the audio/video file comprises embedding a selectable reference to the at least one advertisement in the audio/video file.

5. The method of claim 1, further comprising retrieving a user profile and/or information regarding user behavior, wherein retrieving the at least one advertisement for display comprises retrieving the at least one advertisement for display based upon at least one of the one or more extracted keywords, the user profile, information regarding user behavior, an historic click-through rate, and a monetization value.

6. The method of claim 1, further comprising comparing the one or more extracted keywords to one or more advertising keywords.

7. The method of claim 1, wherein analyzing the audio/video file using speech recognition technology comprises analyzing the audio/video file using enhanced speech recognition technology, the speech recognition technology being enhanced by one or more of augmenting a lexicon, augmenting a language model, and utilizing a user profile and/or information regarding user behavior.

8. The method of claim 1, further comprising determining whether a topic change has occurred.

9. The method of claim 8, wherein if it is determined that a topic change has occurred, the method further comprises re-weighting the one or more extracted keywords based upon historical data.

10. A computer programmed to perform the steps recited in claim 1.

11. A computer system for utilizing content of an audio/video file to select at least one advertisement for display, the computer system comprising:
a receiving component for receiving the audio/video file;
an analyzing component for analyzing the audio/video file using speech recognition technology;
an extracting component for extracting one or more keywords from the audio/video file; and
a retrieving component for retrieving at least one advertisement for display based upon the one or more extracted keywords.

12. The computer system of claim 11, further comprising a displaying component for displaying the at least one advertisement in association with the audio/video file.

13. The computer system of claim 12, wherein the displaying component is capable of embedding the at least one advertisement into the audio/video file.

14. The computer system of claim 12, wherein the displaying component is capable of embedding a selectable reference to the at least one advertisement into the audio/video file.

15. The computer system of claim 11, further comprising a profile retrieving component for retrieving a user profile and/or information regarding user behavior.

16. The computer system of claim 15, wherein the retrieving component is capable of retrieving at least one advertisement for display based upon at least one of the one or more extracted keywords, the user profile, information regarding user behavior, an historic click-through rate, and a monetization value.

17. The computer system of claim 11, further comprising a comparing component for comparing one or more keywords extracted using the extracting component to one or more advertising keywords.

18. The computer system of claim 11, further comprising a determining component for determining whether a topic change has occurred.

19. The computer system of claim 18, wherein if it the determining component determines that a topic change has occurred, the computer system further comprises a re-weighting component for re-weighting the one or more extracted keywords based upon historical data.

20. A computer-readable medium having computer-executable instructions for performing a method, the method comprising:
receiving the audio/video file;
analyzing the audio/video file using speech recognition technology;
extracting one or more keywords from the audio/video file; and
retrieving at least one advertisement for display based upon the one or more extracted keywords.
